(19) United States
(12) Patent Application Publication
(10) Pub. No.: US 2026/0199991 A1
(43) Pub. Date: Jul. 16, 2026

(54) PRELOADED MILLING CUTTERS

(71) Applicant: Kennametal Inc., Latrobe, PA (US)

(72) Inventors: Ruy Frota de Souza Filho, Latrobe, PA (US); Mark A. Francis, Solon, OH (US); Christoph Gey, Furth (DE)

(21) Appl. No.: 19/016,899

(22) Filed: Jan. 10, 2025

(51) Int. Cl. B23C 5/10; B23C 5/28

(52) U.S. Cl. CPC B23C 5/10; B23C 5/28; B23C 2210/241

(57) ABSTRACT

Preloaded milling cutters in which compressive preloads are induced to offset tensile stresses that may otherwise cause crack propagation are disclosed. The preloaded milling cutters include a mounting end for attachment to a milling holder, a cutting end opposite the mounting end, and a body including multiple cutting insert pockets between the mounting end and the cutting end. A central bore extends from the mounting end toward the cutting end, and a tension rod is located within the central bore. The tension rod has an end adjacent the mounting end and an opposite end adjacent the cutting end. A tightening mechanism is engaged with the tension rod to generate tensile stress in the tension rod and reactive compressive stress in the body of the milling cutter. The preloaded milling cutters are capable of withstanding high bending loads and have improved fatigue life. The amount of preload may be adjusted to a desired level. Coolant may be delivered to cutting inserts of the milling cutters with through coolant channels.

### FIELD OF THE INVENTION

The present invention relates to preloaded milling cutters.

### BACKGROUND INFORMATION

Various types of milling cutters are known, such as taper flange mount helical milling cutters. Operation of such milling cutters may generate high side loads causing stress levels that may induce fatigue failures. As a result, cutting parameters may often be limited to avoid excessive loads and damage.

### SUMMARY OF THE INVENTION

The present invention provides preloaded milling cutters in which compressive preloads are induced to offset tensile stresses that may otherwise cause crack propagation. The preloaded milling cutters are capable of withstanding high bending loads and have improved fatigue life. The amount of preload may be adjusted to a desired level. Coolant may be delivered to cutting inserts of the preloaded milling cutters with through coolant channels.

An aspect of the present invention is to provide a milling cutter comprising a mounting end structured and arranged for attachment to a milling holder; a cutting end opposite the mounting end; a body including multiple cutting insert pockets between the mounting end and the cutting end; a central bore extending from the mounting end toward the cutting end; and a tension rod assembly at least partially located within the central bore comprising: a tension rod including a proximal end adjacent the mounting end and a distal end adjacent the cutting end; and a tightening mechanism engaged with the tension rod structured and arranged to generate tensile stress in the tension rod and reactive compressive stress in the body of the milling cutter.

Another aspect of the present invention is to provide a method of pre-loading a milling cutter as described above by generating tensile stress in the tension rod with the tightening mechanism.

These and other aspects of the present invention will be more apparent from the following description.

### BRIEF DESCRIPTION OF THE DRAWINGS

FIG. 1 is a side view of a preloaded helical milling cutter in accordance with an embodiment of the present invention.

FIG. 2 is an end view of the mounting end of the helical milling cutter of FIG. 1.

FIG. 3 is an end view of the cutting end of the helical milling cutter of FIG. 1.

FIG. 4 is a side sectional view taken through section 4-4 of FIG. 3 showing an internal tension rod assembly for preloading the helical milling cutter of FIG. 1.

FIG. 5 is a side view of a preloaded helical milling cutter in accordance with another embodiment of the present invention.

FIG. 6 is an end view of the mounting end of the helical milling cutter of FIG. 5.

FIG. 7 is an end view of the cutting end of the helical milling cutter of FIG. 5.

FIG. 8 is a side sectional view taken through section 8-8 of FIG. 7 showing an internal tension rod assembly for preloading the helical milling cutter of FIG. 5.

FIG. 9 is a side view of a preloaded helical milling cutter in accordance with another embodiment of the present invention.

FIG. 10 is an end view of the mounting end of the helical milling cutter of FIG. 9.

FIG. 11 is an end view of the cutting end of the helical milling cutter of FIG. 9.

FIG. 12 is a side sectional view taken through section 12-12 of FIG. 11 showing an internal tension rod assembly for preloading the helical milling cutter of FIG. 9.

FIGS. 13-17 are various isometric, side and end views of a load-bearing collar for use with a tension rod assembly such as shown in FIGS. 9-12 that allows flow of coolant fluid therethrough.

FIG. 18 is a side view of a preloaded helical milling cutter in accordance with another embodiment of the present invention mounted on a holder of a milling machine.

FIG. 19 is an end view of the cutting end of the helical milling cutter of FIG. 18.

FIG. 20 is a side sectional view taken through section 20-20 of FIG. 19 showing an internal tension rod assembly for preloading the helical milling cutter of FIG. 18.

FIG. 21 is another side sectional view taken through section 21-21 of FIG. 19 showing the internal tension rod assembly.

FIGS. 22-26 are various isometric, side and end views of a load-bearing collar for use with a tension rod assembly such as shown in FIGS. 13-16 that allows flow of coolant fluid therethrough.

FIG. 27 is a side sectional view of a preloaded helical milling cutter in accordance with another embodiment of the present invention including an integral tension rod assembly in accordance with an embodiment of the present invention.

### DETAILED DESCRIPTION

The present invention provides preloaded milling cutters that may reduce crack propagation and failures by inducing compressive stresses in selected portions of the cutters. The compressive stress component may be generated with an internal tension rod such as a tie bar or bolt through the center of the milling cutter. The internal tension rod may be used with flange mount connections where the central part of the cutter provides for connection to the tool holder via bolts on a flange.

As used herein, the term “preloaded” means that the milling cutter is placed into a compressive stress state before being mounted on a holder. A tension rod assembly generates the compressive stress independently of any bolts or other mechanical fasteners used to connect the milling cutter to the holder. As used herein, the term “compressive stress” means a stress that is induced in selected portions of a milling cutter that counteracts tensile stresses that may be generated in the selected regions during operation of the cutter. Compressive stress may be predicted by standard finite element methods or measured by strain gauges.

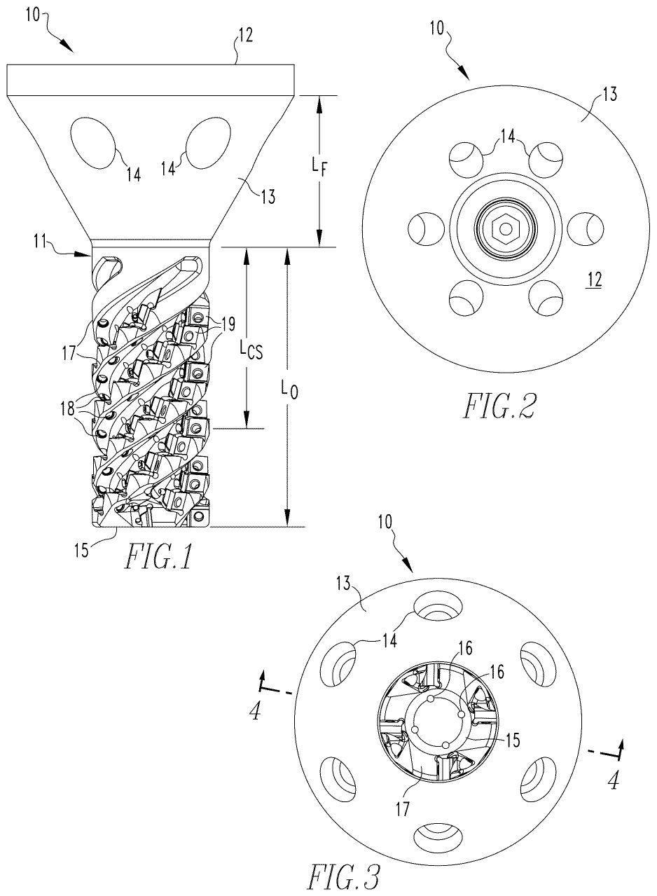

FIGS. 1-4 illustrate a helical milling cutter 10 with a body 11 having a mounting end 12 and a cutting end 15. A taper flange 13 is provided adjacent the mounting end 12 and includes mounting holes 14 extending therethrough for mounting the milling cutter 10 on a conventional milling holder with a flange mount connection. The milling holder may comprise any known type of milling holder, adapter, spindle or the like having a flange mount connection. The cutting end 15 of the milling cutter 10 includes cutting end coolant outlet holes 16. Helical flutes 17 extend axially along the body 11 of the milling cutter 10 from the taper flange 13 to the cutting end 15. In the embodiment shown in FIGS. 1-4, the milling cutter 10 includes four helical flutes 17. However, any other suitable number of helical flutes may be used. Each helical flute 17 includes radial coolant outlet holes 18 and cutting insert pockets 19 for mounting standard milling cutting inserts therein (not shown).

A central bore arrangement 20 is provided in the interior of the milling cutter 10. The central bore arrangement 20 includes a mounting end opening 21 and a countersunk portion 22. The countersunk portion 22 includes a generally cylindrical sidewall 23 and a shoulder 24. The countersunk sidewall 23 has an inner diameter ID_{C} and an axial length of L_{C}. The shoulder 24 of the countersunk portion 22 is located an axial distance D_{C} from the mounting end 15 of the milling cutter 10.

The central bore arrangement 20 includes a central bore 25 having a proximal end 26, a distal end 27, and a cylindrical sidewall 28. The central bore 25 has an inner diameter ID_{B} and an axial length L_{B}. The distal end 27 of the central bore 25 is located an axial distance D_{BM} from the mounting end 12, and an axial distance D_{BC} from the cutting end 15.

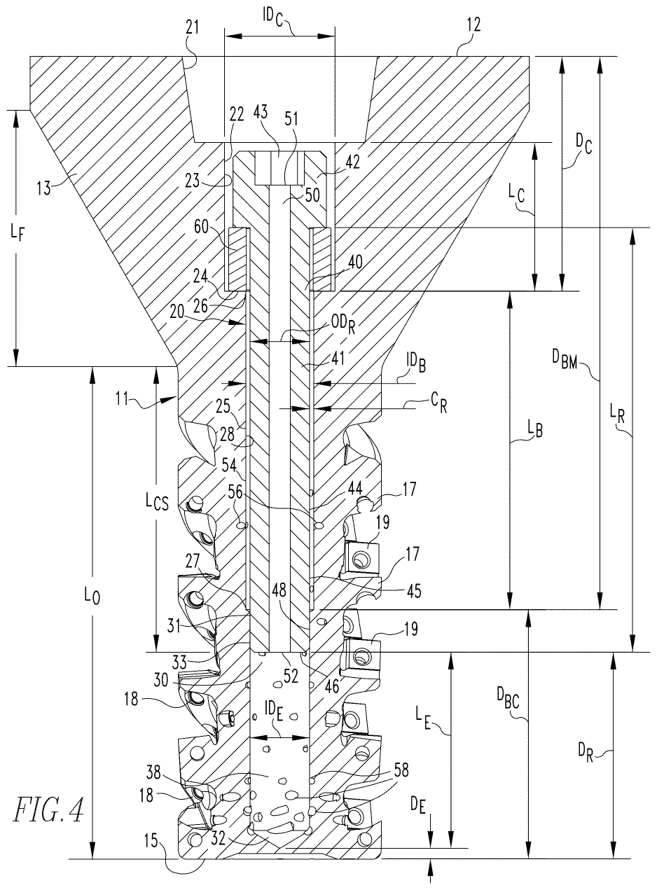

As shown most clearly in FIG. 4, the central bore arrangement 20 includes a tension rod engagement portion 30 adjacent the distal end 27 of the central bore 25. The tension rod engagement portion 30 includes a proximal opening 31, a distal closed end 32, and interior threads 33. A distal coolant reservoir 38 is provided between the proximal opening 31 and the distal closed end 32. The tension rod engagement portion 30 has an inner diameter ID_{E}, an axial length L_{E}, and an axial distance D_{E} of the distal closed end 32 from the cutting end 15 of the milling cutter 10.

As further shown in FIG. 4, a tension rod assembly 40 is installed inside the central bore arrangement 20 of the milling cutter 10. The tension rod assembly 40 includes a tension rod 41 having a proximal head 42 with a tool engagement recess 43 that receives a suitable tool such as an Allen wrench. The tension rod 41 includes a generally cylindrical shaft 44 having an outer surface 45 that provides a clearance space with the central bore 25 in order to allow coolant flow, as more fully described below. The tension rod shaft 44 has a distal end 46 with exterior threads 48. As more fully described below, the exterior threads 48 of the tension rod 41 engage the interior threads 33 of the tension rod engagement portion 30 to generate tensile stress in the tension rod 41 and compressive stress in the body 11 of the milling cutter 10.

The tension rod shaft 44 has an outer diameter OD_{R}. A clearance distance C_{R} is provided between the outer diameter OD_{R} of the tension rod shaft 44 and the inner diameter ID_{B} of the central bore 25. The clearance distance C_{R} may typically be from 0.25 to 4 mm, or from 0.5 to 3 mm. The tension rod shaft 44 has an axial length L_{R} and an axial distance D_{R} measured from the distal end 46 to the cutting end 15 of the milling cutter 10.

As further shown in FIG. 4, the tension rod 41 has a central coolant channel 50 with a proximal coolant channel inlet opening 51 and a distal coolant channel outlet opening 52. An annular coolant channel 54 is provided between the tension rod shaft 44 and the central bore 25. As described above, the annular coolant channel 54 is defined by the clearance distance C_{R} between the outer diameter OD_{R} of the tension rod shaft 44 and the inner diameter ID_{B} of the central bore 25. Radial coolant channels 56 extend from the annular coolant channel 54 to the radial coolant outlet holes 18 located on the helical flutes 17 of the milling cutter 10. In addition, radial coolant channels 58 extend from the distal coolant reservoir 38 to the coolant outlet holes 18 located toward the cutting end 15 of the milling cutter 10.

The body of the milling cutter 10 may be made of any suitable materials such as alloy steels, tool steels, and the like. The tension rod 41 may be made of any suitable material such as alloy steels, tool steels, and the like.

A load-bearing collar 60 surrounds the tension rod shaft 44 and is positioned between the countersunk shoulder 24 and the tension rod head 42. The load-bearing collar 60 transmits compressive force from the tension rod head 42 to the countersunk shoulder 24 when the tension rod 41 is tightened by the engagement of its exterior threads 48 with the interior threads 33 of the engagement portion 30 of the central bore 25. The load-bearing collar 60 may be made of any suitable materials such as alloy steels, tool steels, tungsten carbide and the like. Alternatively, the load-bearing collar may comprise a piezoelectric material, in which case the collar may function as a piezoelectric actuator that may be used to adjust the level of tensile stress in the tension rod 41.

As shown in FIGS. 1-4, as well as other embodiments described below, the generally cylindrical body 11 of the milling cutter 10 has a body length L_{O}, and the taper flange 13 has a taper flange length L_{F}. A region of preloaded compressive stress is generated in the body 11, and may be defined by a compressive strength length L_{CS}. The compressive stress length L_{CS} may be less than the overall length L_{O} of the body, e.g., at least 5 percent less, or at least 10 percent less, or at least 20 percent less. Although a primary goal is to generate the preloaded compressive stress along the L_{CS} length in the body 11, it is to be understood that compressive stress may also be generated in a portion of the taper flange 13 that is adjacent to the body 11.

A preload that generates a compressive stress of at least 50 MPa in the milling cutter body 11, or at least 75 MPa, or at least 100 MPa may be used. For example, the compressive stress may be from 50 to 400 MPa, or from 75 to 350 MPa, or from 100 to 300 MPa. When the tension rod is subjected to tensile stress, the body of the preloaded cutter will have an initial compressive stress as described above. When combined with the stress level of a rotating cutter under bending, the maximum value of the tensile stress will be reduced, while the compressive stress will increase.

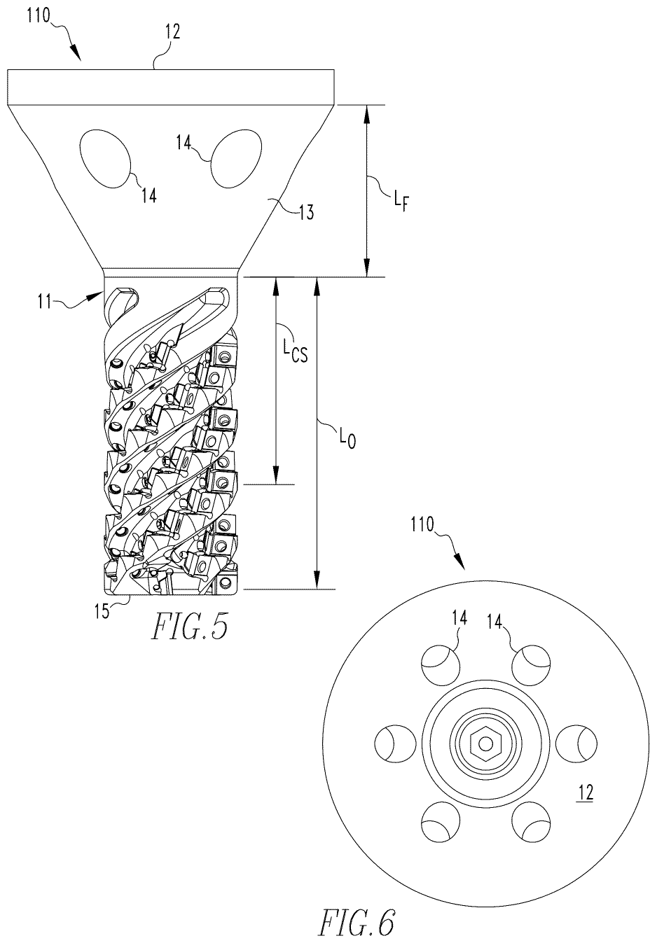

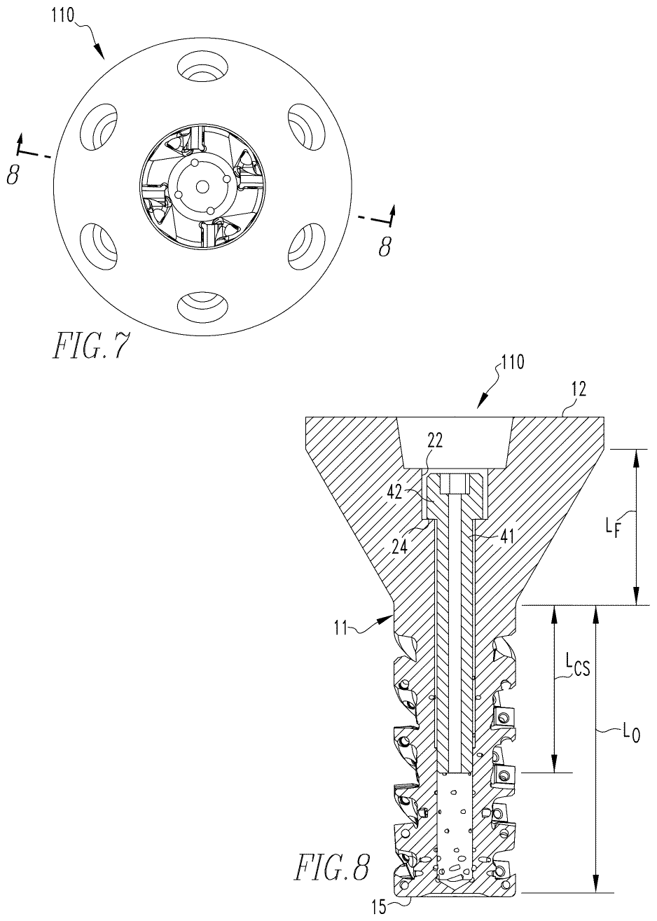

FIGS. 5-8 illustrate another embodiment of a helical milling cutter 110 that is similar to the milling cutter 10 shown in FIGS. 1-4, but with elimination of a load-bearing collar seal. Instead, the head 42 of the tension rod 41 directly contacts the shoulder 24 of the countersunk portion 22 to generate tensile stress in the tension rod 41 and compressive stress in the body 11 of the milling cutter 110. Element numbers appearing in the embodiment of FIGS. 1-4 may also apply to the other embodiments described herein unless otherwise identified.

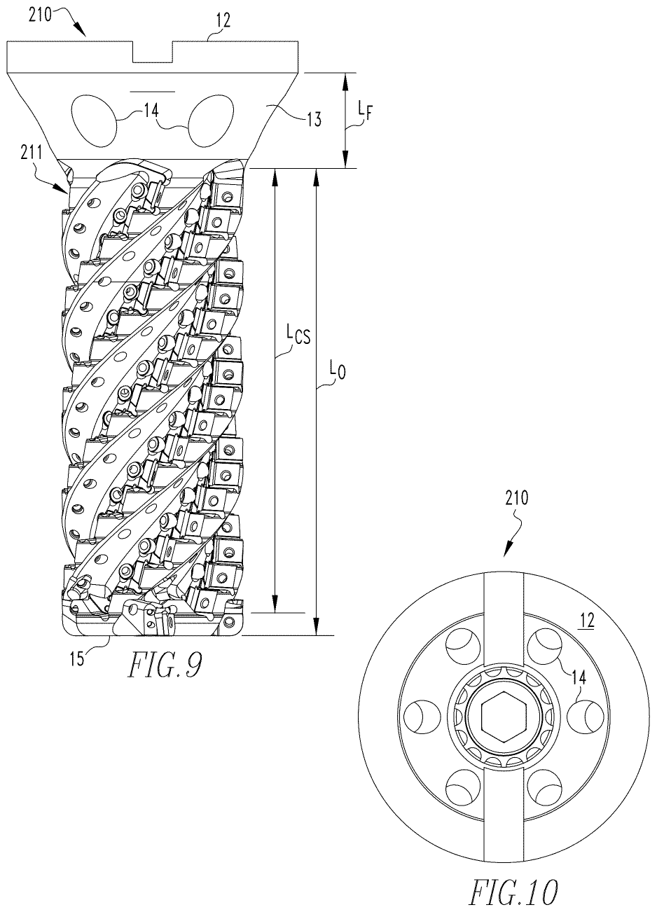

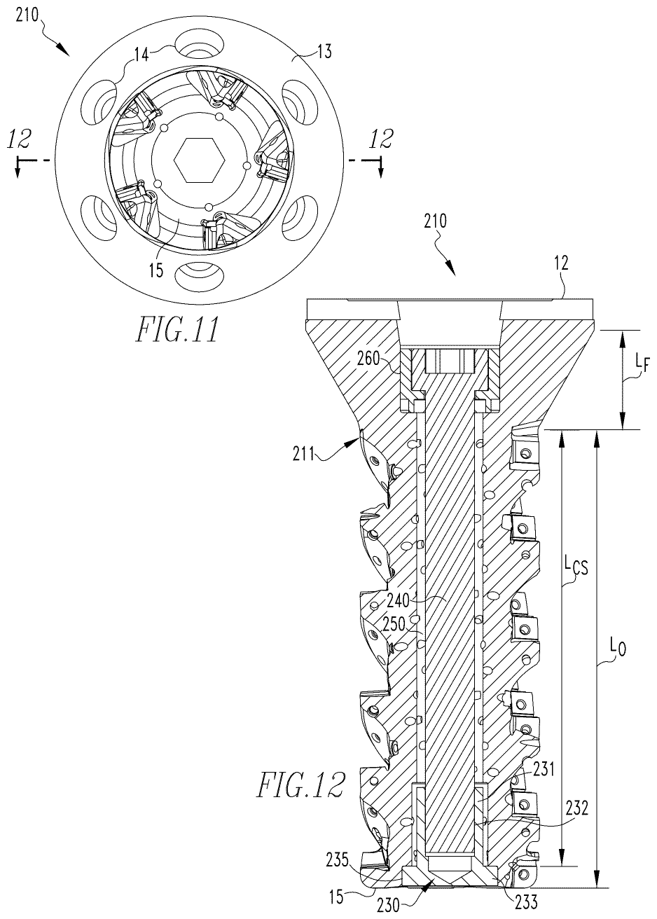

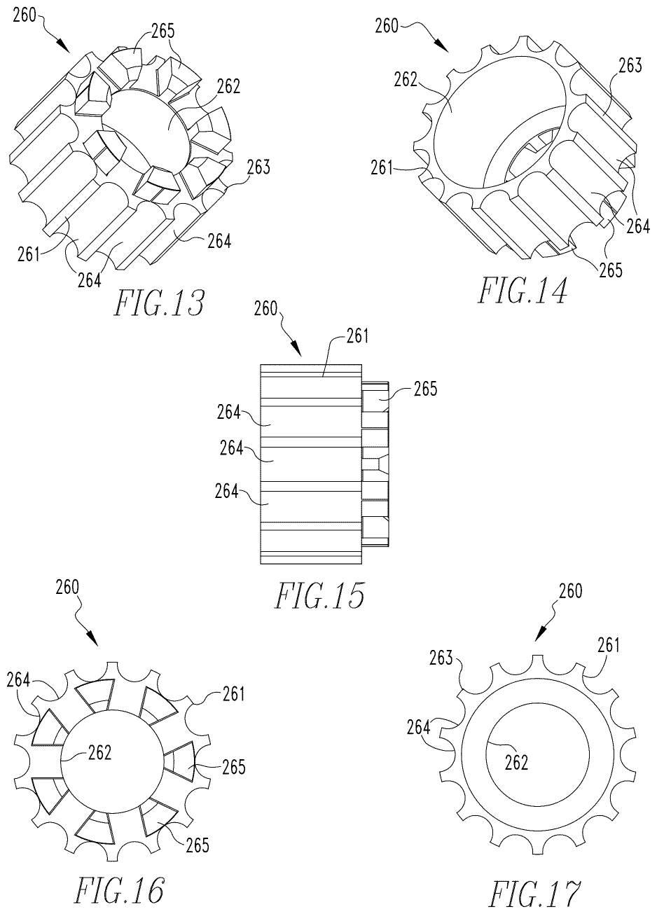

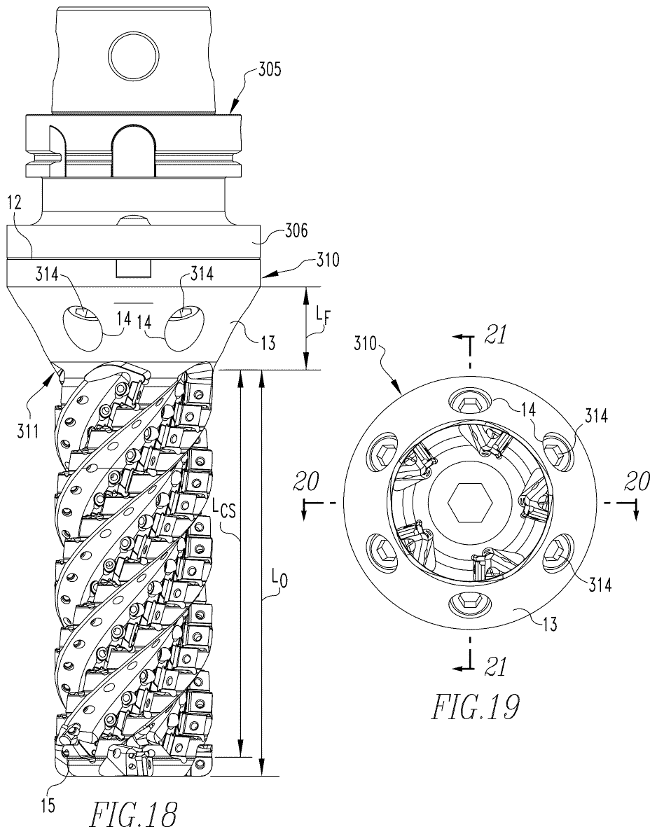

FIGS. 9-17 illustrate another helical milling cutter 210 in accordance with an embodiment of the present invention. The embodiment shown in FIGS. 9-17 is similar to the embodiment shown in FIGS. 1-4, but with a tension rod engagement cap 230 inserted through the cutting end 15 of the body 211 of the milling cutter 210. The tension rod engagement cap 230 includes a cylindrical tension rod-receiving body 231 with internal threads 232. An end flange 233 is provided at the distal end of the cylindrical tension rod-receiving body 231. The tension rod engagement cap 230 is inserted in a countersunk bore 235 located at the cutting end 15. The tension rod engagement cap 230 may be made of any suitable material such as alloy steels, tool steels and the like, and may be secured within the countersunk bore 235 by any suitable means including brazing, press fitting, threading and the like.

As shown in FIG. 12, the tension rod 240 has a solid shaft without a central coolant channel as shown in the previous embodiments. A cylindrical coolant channel 250 surrounds the tension rod 240 and provides a clearance distance C_{R} between the outer diameter of the tension rod 240 and the inner diameter of the central bore cylindrical sidewall 28. The clearance distance C_{R} may have the same or similar dimensions as described in the embodiments above.

As further shown in FIG. 12, a load-bearing collar 260 is provided between the countersunk shoulder 24 of the central bore and the head 42 of the tension rod 240. As shown most clearly in FIGS. 13-17, the load-bearing collar 260 has a generally annular body 261 with a cylindrical inner surface 262 and a channeled outer surface 263. The channeled outer surface 263 includes multiple open coolant fluid channels 264 around the circumference of the collar that allow coolant to flow axially past the collar 260 and into the cylindrical coolant channel 250. Multiple spacer feet 265 extend axially from the collar annular body 261 to allow radial coolant flow through circumferential spaces between the spacer feet 265 into the cylindrical coolant channel 250. The load-bearing collar 260 may be made of any suitable materials such as alloy steels, tool steels, tungsten carbide and the like.

FIGS. 18-21 illustrate another helical milling cutter 310 in accordance with an embodiment of the present invention. The milling cutter 310 is shown mounted to a holder 305 of conventional flange mount design. The milling cutting holder 305 includes a mounting flange 306 with a central extension 307 that extends into the mounting end opening 21 of the central bore arrangement 20. The milling cutter holder 305 includes multiple internally threaded mounting holes 308 for receiving mounting bolts 314 used to secure the milling cutter 310 on the holder 305. A central coolant channel 309 extends through the holder 305, which allows coolant fluid to flow through the holder 305 into the countersunk portion 22 of the central bore arrangement 20.

The helical milling cutter 310 includes a tension rod engagement cap 330 similar to that shown in FIG. 12 inserted into the body 310 of the cutter from its cutting end 15. The tension rod engagement cap 330 includes a cylindrical tension rod-receiving body 331 with internal threads 332, and an end flange 333. A cylindrical coolant channel 350 surrounds the solid tension rod 340. As described above, the cylindrical coolant channel 350 provides a clearance distance C_{R} between the outer diameter of the tension rod shaft 340 and the inner diameter of the central bore 25.

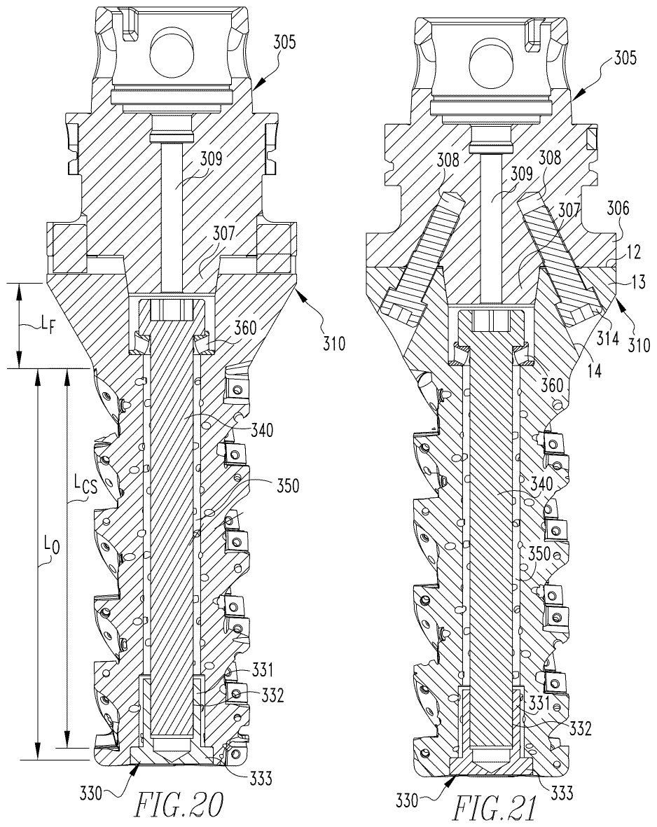

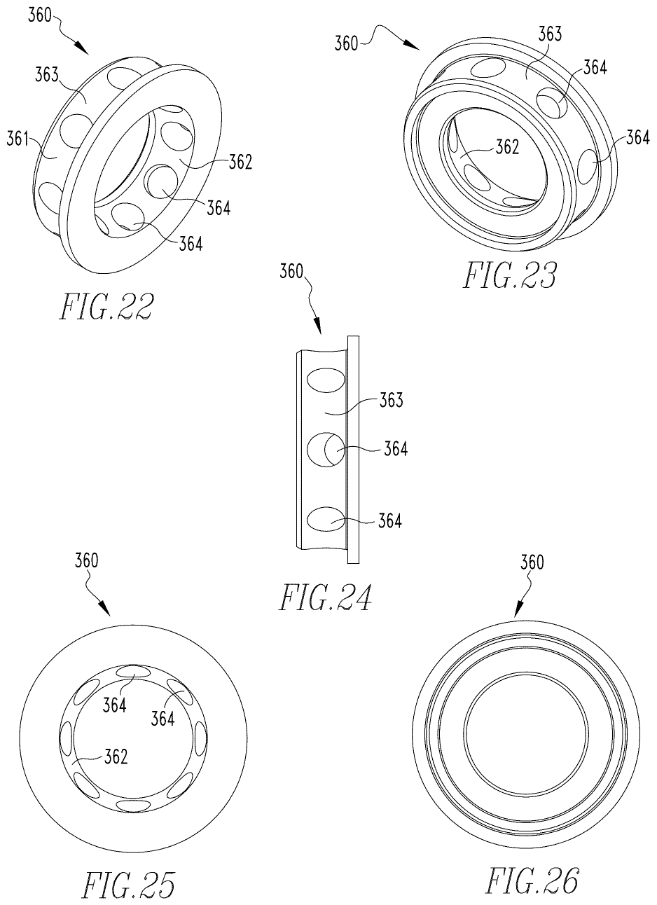

As shown in FIGS. 20, 21 and 22-26, a load-bearing collar 360 includes a generally annular body 361 with a radial inner surface 362 and a radial outer surface 363. Radial coolant through holes 364 are provided between the radial inner and outer surfaces 362 and 363. This arrangement allows coolant fluid to flow radially inward from the countersunk portion 22 into the cylindrical coolant channel 350.

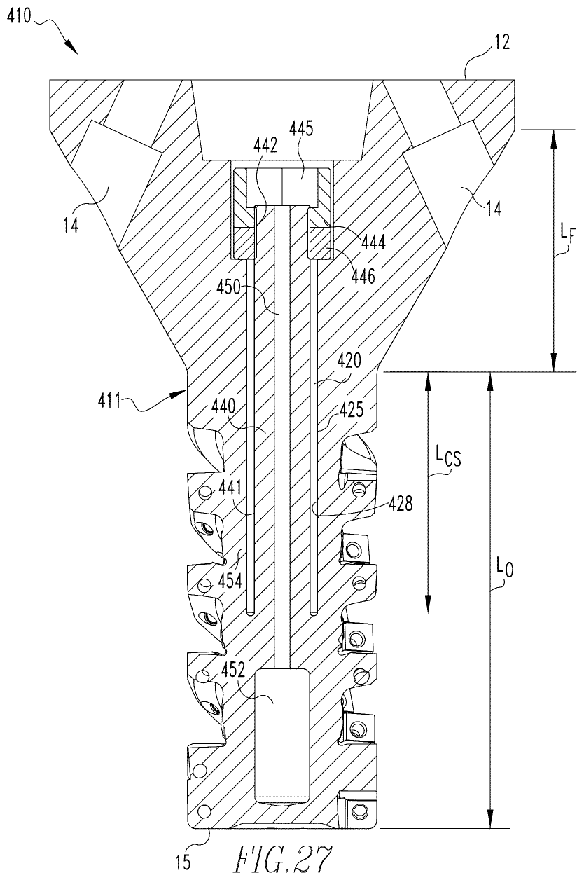

FIG. 27 is a side sectional view of a helical milling cutter 410 in accordance with another embodiment of the invention. The milling cutter 410 includes a cylindrical open space 420 extending axially through the body 411 of the milling cutter 410 that defines a central bore 425 having a cylindrical sidewall 428. The cylindrical open space 420 also defines a tension rod 440 having a cylindrical outer surface 441. In the embodiment shown, the tension rod 440 is integrally formed with the body 411 of the milling cutter 410, e.g., by additive manufacturing. The region between the sidewall 428 of the central bore 425 and the outer surface 441 on the tension rod 440 provides an annular coolant channel 454 having a clearance distance C_{R} as described above. A proximal end of the tension rod 440 includes exterior threads 442 in the region located inside the countersunk portion 22. An interior threaded nut 444 located in the countersunk portion 22 engages the exterior threads 442 of the tension rod 440. Tightening of the nut 444 creates tension in the tension rod 440. An annular load-bearing collar 446 may comprise a piezoelectric material and may function as a piezoelectric actuator to adjust the level of tension in the tension rod 440.

As further shown in FIG. 27, a central coolant channel 450 extends centrally through the tension rod 440. A distal coolant reservoir 452 is provided at the end of the central coolant channel 450. Coolant fluid may thus flow from the countersunk portion 22 into the central coolant channel 450 and into the coolant reservoir 452 for distribution to at least a portion of the cutting end coolant outlet holes 16 and to the radial coolant outlet holes 18 in the helical flutes 17. In addition, coolant fluid may also flow from the countersunk portion 22 into the annular coolant channel 454 for distribution to at least a portion of the radial coolant outlet holes 18.

The milling cutter 410 shown in FIG. 17, as well as the other milling cutters described herein, may be made by any suitable manufacturing techniques including casting, machining, and additive manufacturing. The term “additive manufacturing technique” refers to processes for forming a three-dimensional object by successively adding material to the object layer by layer. The three-dimensional object may be based upon a 3D model of the component object that may be electronically designed as an electronic file having the design parameters. Non-limiting examples of additive manufacturing techniques include binder jetting, directed energy deposition (DED), material extrusion, material jetting, powder bed fusion, sheet lamination, and/or vat photopolymerization. The use of additive manufacturing of the entire rotary cutting tool or the cutting portion may aid in forming the internal tension rods of the present invention.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

1. A milling cutter comprising:
a mounting end structured and arranged for attachment to a milling holder;
a cutting end opposite the mounting end;
a body including multiple cutting insert pockets between the mounting end and the cutting end;
a central bore extending from the mounting end toward the cutting end; and
a tension rod assembly at least partially located within the central bore comprising:
a tension rod including a proximal end adjacent the mounting end and a distal end adjacent the cutting end; and
a tightening mechanism engaged with the tension rod structured and arranged to generate tensile stress in the tension rod and reactive compressive stress in the body of the milling cutter.

2. The milling cutter of claim 1, wherein the tightening mechanism is adjacent to the mounting end.

3. The milling cutter of claim 2, wherein the tightening mechanism comprises a head extending axially from a proximal end of the tension rod having a tool engagement recess.

4. The milling cutter of claim 3, wherein the tension rod comprises external threads at a distal end of the tension rod engaged with internal threads of the central bore.

5. The milling cutter of claim 2, wherein the tightening mechanism comprises an interior threaded nut engaged with external threads on the proximal end of the tension rod.

6. The milling cutter of claim 1, wherein the tightening mechanism comprises a piezoelectric actuator.

7. The milling cutter of claim 1, wherein the central bore comprises a distal end terminating inside the body of the milling cutter.

8. The milling cutter of claim 7, wherein the distal end of the central bore terminates in a tension rod engagement portion having a proximal open end and a distal closed end.

9. The milling cutter of claim 8, wherein a distal coolant reservoir is provided in the tension rod engagement portion.

10. The milling cutter of claim 7, further comprising a tension rod engagement cap extending from the cutting end into the body of the milling cutter.

11. The milling cutter of claim 10, wherein the tension rod engagement cap comprises interior threads engaging exterior threads on the distal end of the tension rod.

12. The milling cutter of claim 1, further comprising an annular coolant channel between an outer surface of the tension rod and an inner surface of the central bore.

13. The milling cutter of claim 12, wherein the annular coolant channel is in flow communication with at least one coolant channel extending through the body of the milling cutter to a coolant outlet hole.

14. The milling cutter of claim 13, wherein the milling cutter comprises at least one helical flute, and the coolant outlet hole comprises a radial coolant outlet hole adjacent to the at least one flute.

15. The milling cutter of claim 13, wherein the coolant outlet hole is located in the cutting end.

16. The milling cutter of claim 12, further comprising a central coolant channel extending through the tension rod.

17. The milling cutter of claim 1, further comprising a central coolant channel extending through the tension rod.

18. The milling cutter of claim 17, wherein the central coolant channel is in flow communication with at least one coolant channel extending through the body of the milling cutter to a coolant outlet hole.

19. The milling cutter of claim 18, wherein the coolant outlet hole is located in the cutting end.

20. The milling cutter of claim 18, wherein the milling cutter comprises at least one helical flute and the coolant outlet hole comprises a radial coolant outlet hole adjacent to the at least one flute.

21. The milling cutter of claim 1, wherein the tensile stress in the tension rod is from 500 to 2,500 MPa.

22. The milling cutter of claim 1, wherein the compressive stress in the body of the milling cutter is from 50 to 300 MPa.

23. The milling cutter of claim 1, wherein the mounting end comprises a taper flange having a plurality of mounting holes extending therethrough structured and arranged to receive mounting bolts for attaching the milling cutter to the milling holder.

24. The milling cutter of claim 23, wherein the mounting holes are spaced circumferentially around the taper flange.

25. The milling cutter of claim 23, wherein the taper flange comprises a generally conical surface.

26. The milling cutter of claim 23, wherein the compressive stress is generated along a portion of an axial length of the body extending between the cutting end and the taper flange.

27. The milling cutter of claim 26, wherein the compressive stress is generated in a region of the body defining a compressive strength length L_{CS} less than an overall length L_{O} of the body.

28. A method of pre-loading a milling cutter according to claim 1, the method comprising generating the tensile stress in the tension rod with the tightening mechanism.
